(19) United States
(12) Patent Application Publication
(10) Pub. No.: US 2011/0236866 A1
(43) Pub. Date: Sep. 29, 2011

(54) Anesthetic Injection Training and Testing System

(76) Inventors: Gregory L. Psaltis, Olympia, WA (US); Dayna L. Dayton, Shelton, WA (US)

(21) Appl. No.: 12/731,789

(22) Filed: Mar. 25, 2010

(51) Int. Cl. G09B 23/28

(52) U.S. Cl. 434/263; 434/270

(57) ABSTRACT

An anesthetic injection training and testing system that allows a practitioner to simulate local anesthetic injections. The anesthetic injection training and testing system may operate in a testing mode or practicing mode. A model of a dental patient has locators dispersed within the model to represent deposition sites for anesthetic. A test tool operated by a practitioner is used to simulate an injection. The test tool operates in cooperation with the locators in order to determine the status of the simulated injection. The test tool and locators may use metal detection to determine the status.

### BACKGROUND

Many dental procedures require a local anesthetic injection. One technique for administering a local anesthetic injection is an infiltration, which numbs one or two teeth. Another technique for administering a local anesthetic injection is a nerve block, which temporarily disables a nerve bundle, which results in numbing a target area. For example, an inferior alveolar nerve block numbs half of the lower jaw so that sensation to half of a patient's lower teeth is temporarily numbed.

Dental schools and hygiene schools teach these dental procedures and have the students practice the procedures using human volunteers, such as fellow students, relatives, and friends. However, it is difficult to get a sufficient number of volunteers for each student to practice the techniques as often as needed. In addition, some dental procedures require a series of steps, which can not be done on the same volunteer on the same day.

### BRIEF DESCRIPTION OF THE DRAWINGS

The features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings in which:

FIG. 1 is a side view of an anesthetic injection training and testing system;

FIG. 2 is a side view of an anesthetic injection training and testing system with an adjustable platform;

FIG. 3 is a cross-sectional view of a model suitable for use in the anesthetic injection training and testing system shown in FIG. 1;

FIG. 4 is a lateral view of two quadrants of a model illustrating an example arrangement of locators, each locator representing a deposition site for a local anesthesia injection in the anesthetic injection training and testing system shown in FIG. 1;

FIG. 5 is a another lateral view of two quadrants of a model illustrating an example arrangement of other locators, each locator representing a deposition site for local anesthesia injections in the anesthetic injection training and testing system shown in FIG. 1;

FIG. 6 is a side view of a test tool that is suitable for use in the anesthetic injection training and testing system shown in FIG. 1;

FIG. 7 is a block diagram illustrating an example computing device 700 that is arranged for implementing portions of the anesthetic injection training and testing system in one embodiment;

FIG. 8 is a functional block diagram generally illustrating components of some embodiments of the anesthetic injection training and testing system shown in FIG. 1; and

FIG. 9 is a flow diagram illustrating processing performed by some embodiments of the anesthetic injection training and testing system shown in FIG. 1.

Embodiments of the present anesthetic injection training and testing system and technique will now be described in detail with reference to these Figures.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

In overview, the anesthetic injection training and testing system provides a dental model that a practitioner or student may use to practice administering local anesthetic injections. By using the anesthetic injection training and testing system, the practitioner and/or student may practice local anesthetic injections without using a human volunteer. In addition, the practitioner and/or student may practice administering local anesthetic injections several times in a short period of time (e.g., a class period). The anesthetic injection training and testing system may also be used to test a student's knowledge of different local anesthetic injections. Hereinafter, the term “user” will refer to a person using the anesthetic injection training and testing system for training and testing purposes.

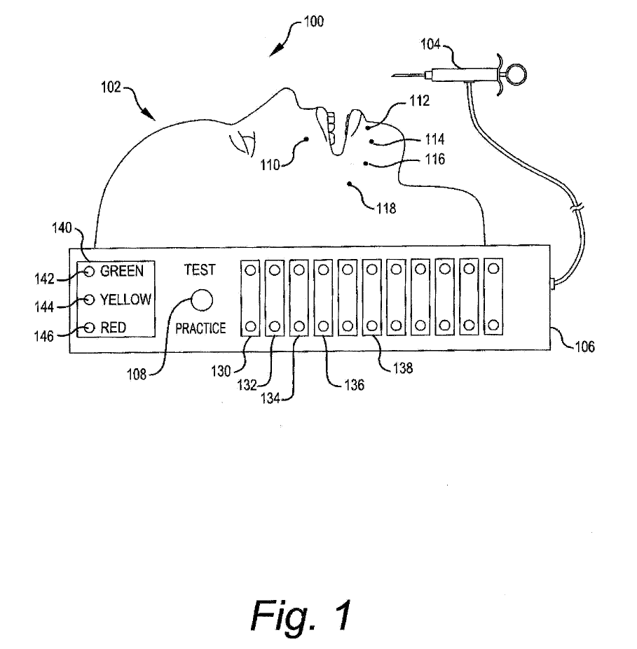

FIG. 1 is a side view of an anesthetic injection training and testing system 100. The anesthetic injection training and testing system 100 includes a model 102, a test tool 104, and a control panel 106. In some embodiments, model 102 may be shaped in the form of a human jaw. The model 102 may also include additional features of a human skull to make the model 102 appear more life-like. For example, model 102 shown in FIG. 1 includes half of a head portion. The model 102 may have several locators (e.g., locators 110-118) dispersed within the model. Each locator may represent a deposition site for administering an anesthetic injection to a dental nerve in a dental patient. Thus, the locators may be positioned within model 102 at varying depths relative to an outer surface of model 102 depending on the corresponding deposition site associated with an injection type, a patient's size, a patient's age, and a patient's dentition. In addition, a size of the locator may vary to reflect different sized regions associated with the corresponding deposition site. Some of the locators may represent deposition sites for a local anesthetic injection, which numbs one or two teeth. Other locators may represent deposition sites for a nerve block, which “blocks” or temporarily disables a nerve bundle. A user (e.g., dental practitioner, dental student) of the anesthetic injection training and testing system 100 may then perform simulated anesthetic injections using a “life-like” environment. Model 102 may be configured in various configurations to support different types of patients, such pediatric dental patients, adolescent dental patients, adult dental patients, and other types of patients.

In some embodiments, model 102 may be shaped in the form of an animal jaw so that veterinarians may use the anesthetic injection training and testing system 100 to practice performing procedures on different types of animals. The positions of the locators within model 102 may then correspond to deposition sites of dental nerves for the respective animal type, such as horses, dogs, cats, and the like.

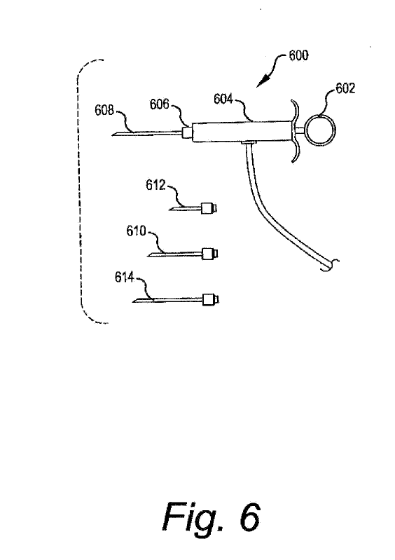

The test tool 104 may be designed in various configurations without departing from the scope of the appended claims. An example configuration for a test tool 104 and an example operation of a test tool is described later in conjunction with FIG. 6. In overview, test tool 104 and locators 110-118 may operate in concert with each other in order to facilitate the practice and testing of dental procedures using the anesthetic injection training and testing system 100.

The control panel 106 includes several selectors (e.g., selectors 130-138). Each selector may correspond to one of the locators 110-118. A user may choose one of the selectors in order to set-up the anesthetic injection training and testing system 100 for simulation of an anesthetic injection of a dental nerve corresponding to the chosen selector. Selectors 130-138 may be toggle switches, touch-sensitive areas on a display, menu-based items on a display, or the like. In some embodiments, the user may choose one selector at a time. In other embodiments, a user may choose multiple selectors. For embodiments that support choosing multiple selectors, the anesthetic injection training and testing system may be configured to activate each of the multiple selectors concurrently in a manner such that the user may run a simulation of multiple injections without stopping to choose another selector after each simulated injection. For example, an instructor may choose multiple selectors on the anesthetic injection training and testing system so that a student may be evaluated on the student's performance for a series of injections.

The anesthetic injection training and testing system may also include a mode selector 108 that may determine a mode of operation for the system, such as a test mode or a practice mode. The anesthetic injection training and testing system may be configured to operate differently depending on the mode selected. For example, in test mode, the anesthetic injection and testing system may be configured to wait until an event signals the completion of the simulated injection before providing a result for the simulated injection. In practice mode, the anesthetic injection training and testing system may be configured to continuously provide a result for the simulated injection so that a user may easily learn a correct location for the deposition site of the dental nerve corresponding to the chosen selector. The mode selector 108 may be a toggle switch that toggles between the test mode and the practice mode, a menu-based option for selecting between two or more modes, a touch-sensitive option provided by a computer generated display, or the like.

The control panel 106 may include a status display 140 that may display results of the simulated injection. As will be described in detail below, the results may be derived from a calculation based on a distance between the test tool and the locator chosen for testing (hereinafter, referred to as the test locator). The results may also be based on a rate of the injection, an angle of the injection, and/or the like.

The control panel 106 may be implemented in various configurations. In one embodiment of the control panel 106, the status display 140 may include different colored lights, such as a green light 142, a yellow light 144, and a red light 146. The anesthetic injection training and testing system may then be configured to provide a status of the simulated injection using the illumination states of the different colored lights. For example, illumination of the green light may indicate that the simulated injection occurred at a correct position on the model for the dental nerve associated with the chosen test locator. Illumination of the yellow light may indicate that the simulated injection occurred in close proximity to the correct position on the model, but not in sufficient proximity to the correct position of the chosen test locator to numb the dental nerve of an actual patient properly. Illumination of the red light may indicate that the simulated injection may not have occurred within sufficient proximity to the correct position and would therefore, not have numbed the dental nerve of an actual patient properly. Some embodiments of the anesthetic injection training and testing system may use other techniques for indicating status, such as having one light that blinks in different patterns to indicate results of the simulated injection, having an audible indicator to indicate results, having a print-out of results, and/or the like.

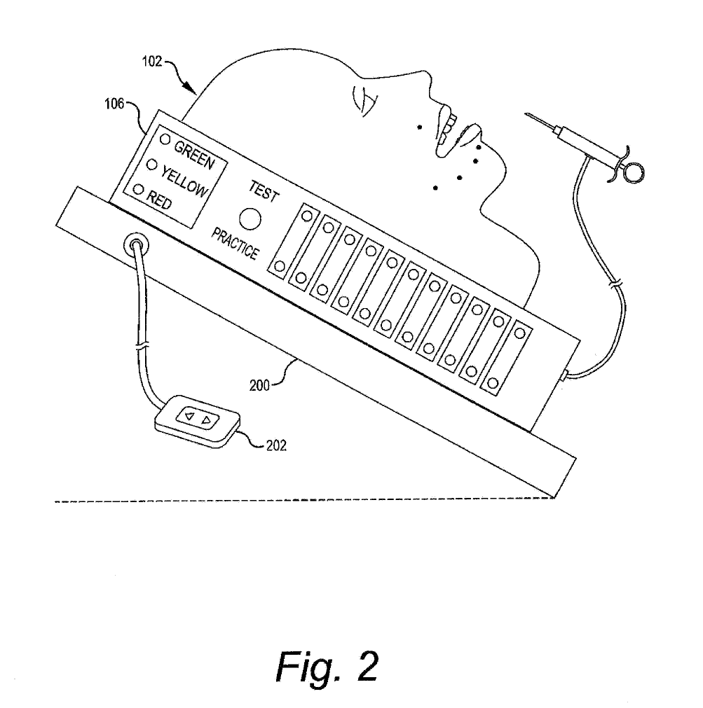

FIG. 2 is a side view of an anesthetic injection training and testing system with an adjustable platform. Some embodiments of the anesthetic injection training and testing system may include adjustable platform 200 on which the model 102 and/or control panel 106 may be mounted. The platform 200 may be adjustable by an adjusting means 202, such as a lever, a knob, a foot pedal, or the like. The adjustable platform may allow the model 102 to be moved to one out of a range of positions from an upright position to a prone position. The range of positions supports different user's preferences for performing the different dental injections.

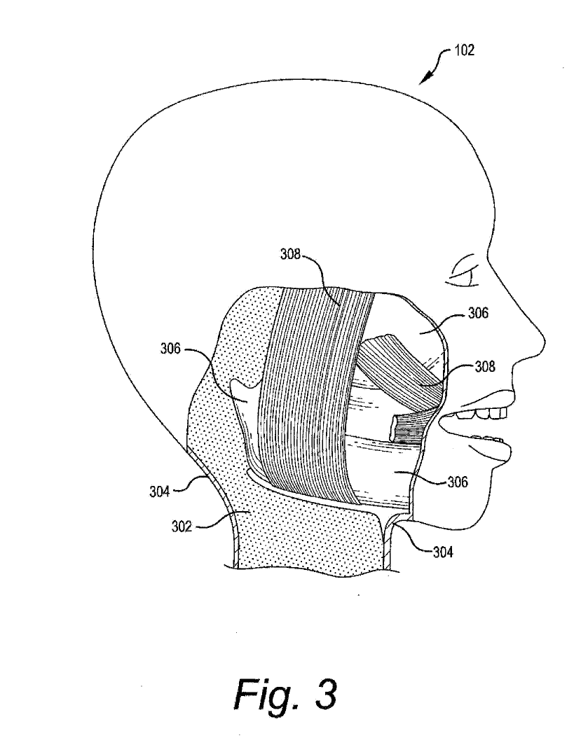

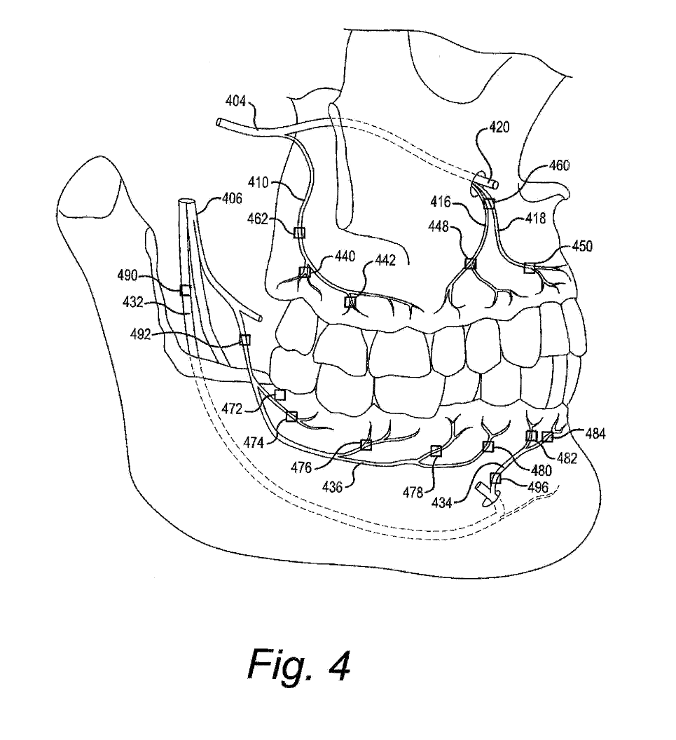

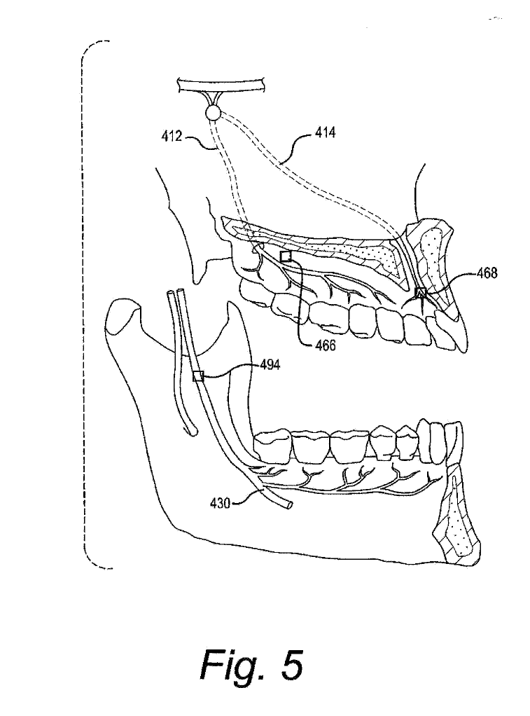

FIG. 3 is a cross-sectional view of a model 102 suitable for use in the anesthetic injection training and testing system shown in FIG. 1. In some embodiments, model 102 may include a structure layer 302 and a skin layer 304. The structure layer 302 may provide a structure for the shape of model 102. The skin layer 304 may overlay the structure layer 302 and may help protect the structure layer during simulated injections. The structure layer may be a semi-rigid material, in which locators may be positioned at various depths. The structure layer may allow penetration by a needle during a simulated injection. The locators may be placed during the manufacturing process of the structure layer or may be placed on and/or in the structure layer at a later time. Placement of the locators within model 102 will be described below in conjunction with FIGS. 4-5.

The skin layer 304 may be a malleable material that may help protect the structure layer 302. In some embodiments of model 102, the skin layer may be removable so that the skin layer may be replaced with a new skin layer after several simulated injections have been performed so that the skin layer does not provide any clue to the user as to the correct position of the deposition site for any of the locators. The skin layer 304 of the model may be made from material used in conventional medical training dummies and/or any other material that is penetrable but retains its shape after penetration. The elasticity of the skin layer 304 may allow the skin layer to stretch over the structure layer and then conform to the contours of the structure layer. In some embodiments, the skin layer 304 may accommodate different skin textures by varying the elasticity, the thickness, and other properties of the material for different types of dental patients. For example, the skin layer may be made to have less elasticity when used for practicing dental procedures on elderly patients and the skin layer may have different properties for patients of different ethnic groups.

Model 102 may also include additional layers, such as bone layer 306 that represents a bone structure of a dental patient and/or muscle layer 308 that represents a muscle structure of a dental patient. The bone layer 306 may be rigid material that simulates the density of the actual bones. The muscle layer 308 may be malleable, but tougher than the skin layer, to simulate the difference between penetrating soft tissue and muscle in actual dental patients. In some embodiments, the bone layer 306 may overlay the structure layer 302 and then the muscle layer 308 may overlay the bone layer 306 with the skin layer 304 as the outermost layer of model 102. A user may replace layer 306 and/or 308 individually after several injections if the layer exhibits wear and tear. In some embodiments, layers 306 and 308 may be combined into one layer representing both the bone structure and the muscle structure of a dental patient.

FIG. 4 is a lateral view of two quadrants of a model illustrating representative placement of locators that correspond to deposition sites in a dental patent for administering anesthetic injections. Because anesthetic injections work by having anesthetic contact nerve fibers that carry impulses to the brain or contacts with the small nerve endings that pick up sensations in the tissue, the locators are placed within the model to correspond to the optimal location of the deposition site for simulating each injection.

The model may be configured for simulating one or more injections. Some of the locators may correspond to an infiltration, which is a local anesthetic injection that numbs one or two teeth. Other locators may correspond to a nerve block, which is a local anesthetic injection that blocks or temporarily disables a nerve bundle. For convenience, some of the dental nerves are shown in FIGS. 4 and 5 to provide a visual aid in understanding the placement of the locators within the model. Reference numerals in the following discussion refer to elements shown in FIG. 4, unless otherwise noted as referring to FIG. 5. Representations of the dental nerves need not be part of model 102, but may be included for training purposes. The dental nerves include a maxillary nerve branch 404 and a mandibular nerve branch 406 of a trigeminal nerve (not shown). The maxillary nerve branch 404 includes a posterior superior alveolar branch 410, a greater palatine nerve 412 (shown in FIG. 5), a lesser palatine nerve 414 (shown in FIG. 5), a middle superior alveolar branch 416, an anterior superior alveolar branch 418, and an infra-orbital nerve 420. The mandibular nerve branch 406 includes a lingual nerve 430 (shown in FIG. 5), an inferior alveolar nerve 432, a mental nerve 434, and a buccal nerve 436.

Model 102 may include one or more maxillary local anesthesia injection locators. A maxillary tooth locator (e.g., maxillary tooth locators 440-450) may be positioned near an apex of an associated tooth near a corresponding small terminal nerve branch. Typically, dental personnel perform infiltration on the maxillary anterior teeth, however, model 102 may include locators for the maxillary posterior teeth (maxillary tooth locators 440-444) as shown.

Model 102 may also include one or more maxillary nerve block locators. Anterior superior alveolar nerve block locator 450 may be positioned at the height of the mucobuccal fold mesial to the cuspid to simulate the numbing for the maxillary central and lateral incisors and cuspid in one quadrant. Posterior superior alveolar (PSA) nerve block locator 462 may be positioned at the apex of the second molar toward the distobuccal root to simulate the numbing for the maxillary second and third molars and the distobuccal of the first molar. Middle superior alveolar (MSA) nerve block locator 448 may be positioned between the bicuspids to simulate the numbing of both bicuspids or the numbing of the mesial root of the first molar. Greater palatine nerve block locator 466 (FIG. 5) may be positioned anterior to the greater palatine foramen, middle of the maxillary second molar on the palate to simulate the numbing of the hard palate and soft tissues covering the hard palate from the distal of the canine posteriorly. Nasopalatine nerve block locator 468 (FIG. 5) may be positioned near the lingual tissue adjacent to the incisive papilla to simulate the numbing of the anterior one-third of the hard palate from the canine to the central incisor. Infraorbital nerve block locator 470 may be positioned above the bicuspids approximate to infraorbital foramen to simulate the numbing of the buccal and pulpal tissues in the anterior teeth and bicuspids and the skin of the lower eyelid, side of nose, cheek, and upper lip.

Model 102 may include one or more mandibular local anesthesia injection locators. A mandibular tooth locator (e.g., mandibular tooth locators 472-484) may be positioned near an apex of an associated tooth near a corresponding small terminal nerve branch. Model 102 may also include one or more mandibular nerve block locators. Inferior alveolar nerve block locator 490 may be positioned inside of the mandibular ramus, posterior to the retro-molar pad, below and anterior to the mandibular foramen to simulate the numbing of the mandibular quadrant including the teeth, mucous membrane, and periosteum. Buccal nerve block locator 492 may be positioned near the mucous membrane to the distal and toward the buccal of the last mandibular molar tooth in the arch to simulate the numbing of the buccal tissue adjacent to the mandibular molars only. A lingual nerve block locator 494 may be positioned lingual to mandibular ramus to simulate the numbing of the lingual tissues and side of the tongue. Mental nerve block locator 496 may be positioned anterior to the mental foramen, between the apices of the roots of the mandibular premolars to simulate the numbing of the mandibular premolars, canines, and facial tissues adjacent to these teeth.

While FIGS. 4-5 illustrate positions for the locators in model 102, one will recognize that FIGS. 4-5 are not shown to scale. The actual position, depth, and size of each locator within model 102 may be determined using knowledge of those skilled in the art of dental procedures and may vary based on whether a patient is a child, an adolescent, or an adult. In addition, the position of the locators may not correspond to the actual deposition sites of a patient in some embodiments of the anesthetic injection training and testing system. For example, if the anesthetic injection training and testing system implements a metal detection technique for determining the status of the simulated injections, the locators may be positioned at a deeper depth than the actual deposition site so that the locators do not block or interfere with the penetration of the syringe into the model. These and other variations for the positioning of the locators within model can be determined using knowledge of those skilled in the art of dental procedures.

FIG. 6 is side view of an embodiment of a test tool that is suitable for use in the anesthetic injection training and testing system shown in FIG. 1. In this embodiment, the test tool may be shaped like a syringe 600. The syringe 600 includes a plunger 602, a barrel 604, a needle hilt 606, and a needle 608. A user may insert the needle 608 into model 102 in order to simulate the administration of a local anesthetic to one of the dental nerves. The needle hilt 606 may allow interchangeability of needles 608 to support different types of injections. For example, a short needle 610 may be used for performing upper adult injections and/or pediatric mandibular blocks. An extra short needle 612 may be used for performing many pediatric injections. A long needle 614 may be used to perform a lower block on an adult model. In some embodiments, the needle 608 may be made of metal that may be detectable by a metal detector. For these embodiments, each of the locators positioned in the model may be configured as a metal detector that is activated when the corresponding selector is chosen. Thus, the one locator that is activated will sense the proximity of the needle 608 and provide an audible signal and/or visual indication of the status. The status may be provided in real-time if the anesthetic injection training and testing system is operating in the practice mode. If the anesthetic injection training and testing system is operating in test mode, the status may be provided after an event occurs that signals the deposition of the simulated anesthetic at the deposition site. For example, the event may be pushing the plunger of the test tool, stepping on a foot pedal, or the like. As a further refinement, the test tool may be configured to measure the rate of injection, the status of which may be displayed separately and/or factored into the status determined on the position of the injection.

Some embodiments of the anesthetic injection training and testing system may use a metal detection technique for evaluating simulated anesthetic injections. Each locator interacts with the test tool (not shown) in a manner such that a simulated anesthetic injection may be evaluated. For example, in some embodiments, each locator may be configured as a metal detector. When the corresponding selector is switched to a “selected” position, the metal detector corresponding to the selected locator may become activated and begin detection for a metal material. In this embodiment, the test tool includes a metal material detectable by the metal detector. In another embodiment, the test tool may be configured as the metal detector and each of the locators may be a metal material detectable by the metal detector. In some other embodiments, different locators may be made with different types of material detectable by a metal detector, which aids in distinguishing among different locators. In yet other embodiments, each locator and test tool may be configured to close a circuit when the simulated deposition occurs at the correct location.

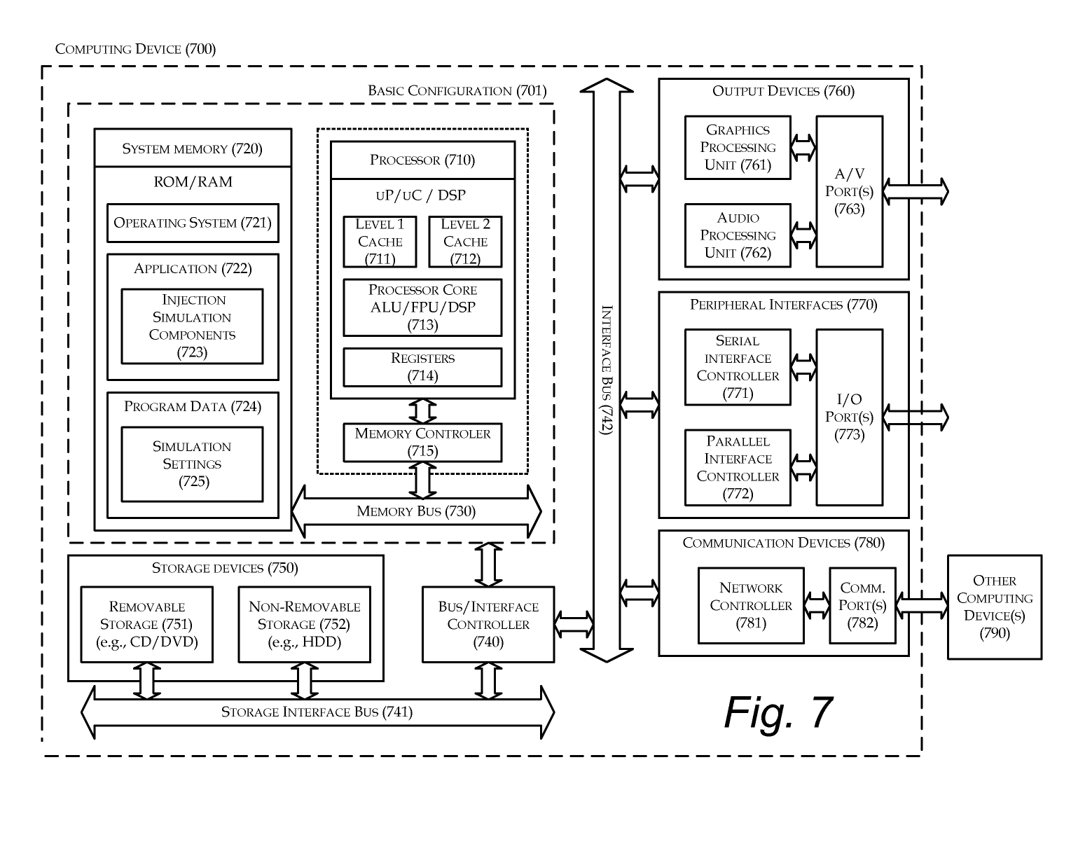

FIG. 7 is a block diagram illustrating an example computing device 700 that is arranged for implementing portions of the anesthetic injection training and testing system in one embodiment. In a basic configuration 701, computing device 700 typically includes one or more processors 710 and system memory 720. A memory bus 730 can be used for communicating between the processor 710 and the system memory 720. Depending on the desired configuration, processor 710 can be of any type including but not limited to a microprocessor (pP), a microcontroller (pC), a digital signal processor (DSP), or any combination thereof. Processor 710 can include one or more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the processor 710, or in some implementations the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 typically includes an operating system 721, one or more applications 722, and program data 724. Application 722 includes one or more anesthetic injection simulation components 723 that provide the functionality for the anesthetic injection training and testing system. Program data 724 includes simulation settings 725 that are used when a practitioner is testing or practicing a simulated injection. This described basic configuration is illustrated in FIG. 7 by those components within dashed line 701.

Computing device 700 can have additional features or functionality, and additional interfaces to facilitate communications between the basic configuration 701 and any required devices and interfaces. For example, a bus/interface controller 740 can be used to facilitate communications between the basic configuration 701 and one or more data storage devices 750 via a storage interface bus 741. The data storage devices 750 can be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 720, removable storage 751, and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include an interface bus 742 for facilitating communication from various interface devices (e.g., output interfaces, peripheral interfaces, and communication interfaces) to the basic configuration 701 via the bus/interface controller 740. Example output devices 760 include a graphics processing unit 761 and an audio processing unit 762, which can be configured to communicate to various external devices such as a display or speakers via one or more A/V port 763. Example peripheral interfaces 770 include a serial interface controller 771 or a parallel interface controller 772, which can be configured to communicate with external devices such as input devices (e.g., keyboard, mouse, pen, voice input device, touch input device, etc.) or other peripheral devices (e.g., printer, scanner, etc.) via one or more I/O ports 773. An example communication device 780 includes a network controller 781, which can be arranged to facilitate communications with one or more other computing devices 790 over a network communication via one or more communication ports 782. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 700 can be implemented as a personal computer including both laptop computer and non-laptop computer configurations and can be implemented within an electronic device. There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

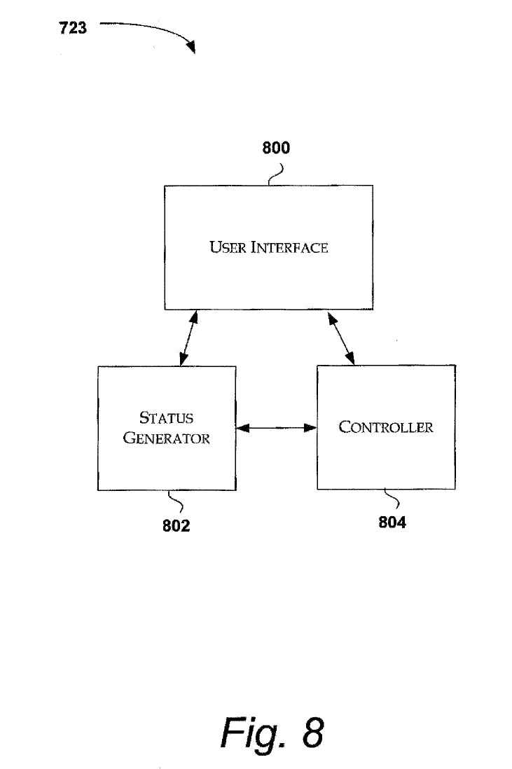

FIG. 8 is a functional block diagram generally illustrating components of one embodiment of the anesthetic injection training and testing system shown in FIG. 1. The anesthetic injection training and testing system includes a controller 800, a user interface 802, and a status generator 804. The user interface controller 802 accepts inputs from a practitioner/student and configures the anesthetic injection training and testing system accordingly. The controller 800 controls the functioning of the anesthetic injection training and testing system. The status generator 804 may display and/or provide the status of the simulated dental injection.

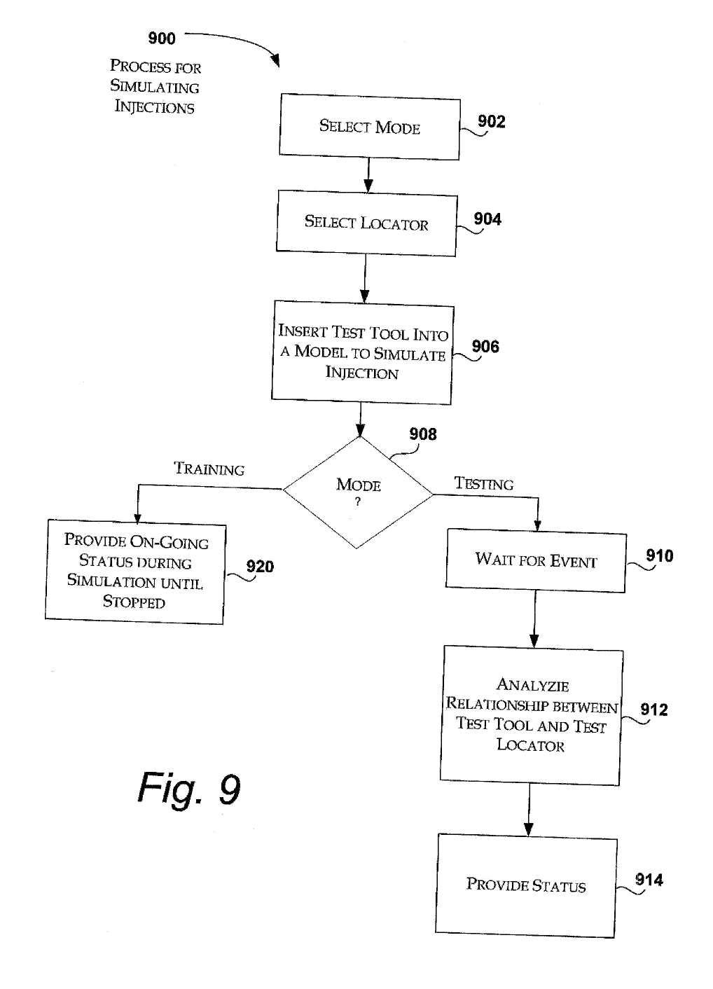

FIG. 9 is a flow diagram illustrating processing performed by the anesthetic injection training and testing system shown in FIG. 1. At block 902, a mode may be selected. Different modes allow the anesthetic injection training and testing system to operate in various modes, such as a testing mode, a training mode, or other mode. The selection of the mode may be performed with a mechanical means (e.g., toggle switch), an electrical means, a software means, and any variation and combination of the above. When the anesthetic injection training and testing system is configured in testing mode, the anesthetic injection training and testing system may not provide any indication of status of the injection procedure until a certain event takes place. When the anesthetic injection training and testing system is configured in training mode, the anesthetic injection training and testing system may provide an indication of status of the injection procedure as the user performs the simulated injection.

At block 904, a deposition site for the simulated anesthetic injection is selected. The selection of the deposition site may be performed with a mechanical means, an electrical means, a software means, and any variation and combination of the above. For example, the selection of the deposition site may occur using a touch screen display. One deposition site may be selected at a time. However, in some embodiments, multiple concurrent deposition sites may be entered so that a user may practice multiple injections without stopping to select the next deposition site.

At block 906, a test tool is inserted into a model to simulate an anesthetic injection. The test tool interacts with the locators embedded in the model.

At block 908, a decision is made whether the system is operating in testing mode or training mode. If the system is configured for testing mode, processing continues at block 910. If the system is configured for training mode, processing continues at block 920.

At block 910, the system waits until an event occurs indicating when to test the simulated injection. The event may be the action of pulling back on a trigger of the test tool, stepping on a pedal, or the like. These and other events signal the system that the user is ready to evaluate the simulated injection.

At block 912, upon detection of the event, the system analyzes the relationship between the test tool and the test locator. The relationship may be based on a strength of a signal, closing an open circuit, and/or the like.

At block 914, status of the relationship is provided. The status may be an audible sound and/or a visual display. For example, a printout may be printed with the results, a voice may speak the results, a different pitch, or volume of sound may indicate the results, multi-colored lights may display the results, and the like. In another embodiment, the status may not be provided until a simulated injection is performed at each of the concurrent testing locators.

At block 920, the system provides an indication of the status while the injection is being performed. Thus, the user may receive feedback while performing so that the user may make adjustments to obtain a successful injection. The indication of the status may be audible and/or visual. The status may be an audible sound and/or a visual display. For example, a printout may be printed with the results, a voice may speak the results, a different pitch, or volume of sound may indicate the results, multi-colored lights may display the results, and the like. In some embodiment, the status may not be provided during training mode because the user may have been provided on-going status during the injection procedure.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into a anesthetic injection training and testing system. That is, at least a portion of the devices and/or processes described herein can be integrated into a anesthetic injection training and testing system via a reasonable amount of experimentation. Those having skill in the art will recognize that an embodiment for the anesthetic injection training and testing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermeddle components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly intractable and/or wirelessly interacting components and/or logically interacting and/or logically intractable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments have been disclosed herein, other aspects and embodiments will be apparent to those skilled in art. The various embodiments disclosed herein are for purposes of illustration and are not intended to be limiting, with the true scope and spirit being indicated by the following claims.

What is claimed is:

1. An anesthetic injection training and testing system, comprising:
a model representing at least a jaw of a dental patient, the model having a plurality of locators, each locator representing a deposition site for injecting a local anesthesia into a dental nerve of the dental patient;
a test tool for simulating administration of the local anesthesia at one of the deposition sites; and
a control panel for displaying results from simulating the administration of the local anesthetic, the results being determined using a metal detector and being based on a distance between the test tool and a test locator during the simulation, the test locator being one of the plurality of locators in the model.

2. The anesthetic injection training and testing system of claim 1, wherein the dental nerve comprises a single nerve that numbs one tooth when the local anesthesia is administered to the single nerve.

3. The anesthetic injection training and testing system of claim 1, wherein the respective dental nerve comprises a nerve bundle that numbs a plurality of teeth when the local anesthesia is administered to the nerve bundle.

4. The anesthetic injection training and testing system of claim 1, wherein the test tool comprises the metal detector and the locator comprises a material detectable by the metal detector.

5. The anesthetic injection training and testing system of claim 1, further comprising a platform upon which the model is mounted.

6. The anesthetic injection training and testing system of claim 5, wherein the platform is adjustable.

7. The anesthetic injection training and testing system of claim 5, wherein the platform is adjustable in a manner such that the model adjusts between a prone position and an upright position.

8. The anesthetic injection training and testing system of claim 1, wherein the test tool comprises a syringe-like device.

9. The anesthetic injection training and testing system of claim 1, further comprising a mode selector that determines the manner in which the results are analyzed.

10. The anesthetic injection training and testing system of claim 9, wherein the mode selector includes a test mode and the results are analyzed when an event occurs that indicates completion of the simulation.

11. The dental mannequin of claim 9, wherein the mode selector includes a practice mode and the results are analyzed as the test tool simulates administration of the anesthesia.

12. A method for simulating administration of a local anesthetic, comprising:
selecting a mode on a control panel;
inserting a test tool into a model that represents at least a jaw of a dental patient, the model having a plurality of locators, each locator representing a dental nerve in the patient; and
activating a control that signals the control panel to display results from the insertion of the test tool into the model, the results being based on metal detection between the test tool and the plurality of locators.

13. The method of claim 12, wherein activating the control comprises pulling a trigger on the test tool.

14. The method of claim 12, wherein activating the control comprises stepping on a pedal.

15. The method of claim 12, wherein selecting the mode comprises moving a toggle switch on the control panel between a practice mode and a test mode.

16. The method of claim 12, further comprising analyzing a location of the test tool in relation to one of the locators to determine the results.

17. The method of claim 16, wherein analyzing comprises producing an audible sound based on the proximity of the test tool and the one locator, the test tool comprising a metal detector and the locator comprising a material detectable by the metal detector.

18. A dental mannequin, comprising:
a model representing at least a jaw of a dental patient;
a layer that covers the model to simulate skin of the dental patient;
a plurality of locators dispersed under the layer, each locator representing a respective deposition site of the dental patient, the locator cooperating with a test tool that simulates administration of a local anesthesia at one of the respective deposition sites, the cooperation of the locator and test tool being based on metal detection.

19. The dental mannequin of claim 18, wherein the test tool comprises a metal detector and the locator comprises a material detectable by the metal detector.

20. The anesthetic injection training and testing system of claim 18, wherein the locator comprises a metal detector and the test tool comprises a material detectable by the metal detector.
